(19) United States
(12) Patent Application Publication
(10) Pub. No.: US 2003/0166804 A1
(43) Pub. Date: Sep. 4, 2003

(54) Trivalent organic lanthanoid complex, catalyst for production of (meth) acrylic polymer, and (meth) acrylic polymer

(76) Inventors: Hajime Yasuda, Hiroshima (JP); Yuushou Nakayama, Hiroshima (JP); Michiharu Yamamoto, Osaka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/370,926

(22) Filed: Feb. 20, 2003

(30) Foreign Application Priority Data
Feb. 26, 2002 (JP) 2002-49007

(51) Int. Cl. C08F 4/72; C07F 5/00

(52) U.S. Cl. 526/170; 534/15

(57) ABSTRACT

This invention provides an easily synthesized trivalent organic lanthanoid complex which can be used as a polymerization catalyst for (meth) acrylic monomers. The trivalent organic lanthanoid complex is represented by the general formula (1):

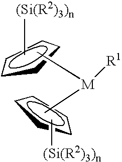

wherein M represents Sc, Y or a lanthanide atom, R¹ represents a hydrogen atom, a C₁₋₁₀ alkyl group or a C₁₋₁₀ alkyl group containing a silicon atom, R² groups independently represent a C₁₋₁₀ alkyl group, and n is 1 or 2.

### BACKGROUND OF THE INVENTION

1. Field of the Invention

The present invention relates to a trivalent organic lanthanoid complex. The trivalent organic lanthanoid complex is useful as a catalyst for production of (meth) acrylic polymers and used preferably in production of (meth) acrylic polymers.

2. Description of the Related Art

It is known that a highly stereoregularity polymer can be obtained from methyl methacrylate which is a typical (meth) acrylic ester, by low-temperature radical polymerization or low-temperature anionic polymerization. It is known that the methacrylic polymer thus obtained has higher stereoregularity and a narrower distribution of molecular weights than those of methacrylic polymers synthesized by usual radical polymerization, is excellent in moldability, and has specific characteristics.

Heretofore, the stereoregular polymerization of methyl methacrylate has been extensively studied. For example, when methyl methacrylate is polymerized by adding ZrMe₂ (in this specification, Me refers to CH₃) or Zr(C₂H₅)₂ and B(C₆F₅)₃ to ethylene bisindenyl, a highly isotactic polymer is obtained, but its number-average molecular weight is as low as 20,000 and the yield is also as low as 38% (K. Soga, H. Deng, T. Yano, T. Shion, Macromolecules, 27, 7938, 1994). Further, a method of using a Grignard reagent, a method of using lithium as an initiator in liquid ammonia, and a method of using 1,1-diphenylhexyl lithium are known. In these methods, relatively monodisperse (Mw/Mn˜about 1.5) poly (methyl methacrylate) can be obtained, but these methods are insufficient to prepare a syndiotactic polymer having a high molecular weight and a narrower distribution of molecular weights.

Various studies have been made to solve the problem described above. For example, use of a trivalent lanthanoid, complex as a catalyst for polymerization of methyl (meth) acrylate has been disclosed in recent years by Yasuda et al. (JP-A 3-263412). In this method, poly (meth) acrylic ester having a very narrow dispersion degree of 1.04, a high molecular weight (Mn=194000) and 80% or more syndiotacticity in 3-units expression (% rr) can be produced in 98% yield.

A pentaalkyl cyclopentadienyl type organic lanthanoid complex disclosed in JP-A 3-263412 supra can be synthesized from a starting pentaalkyl cyclopentadienyl salt by the reaction scheme 2:

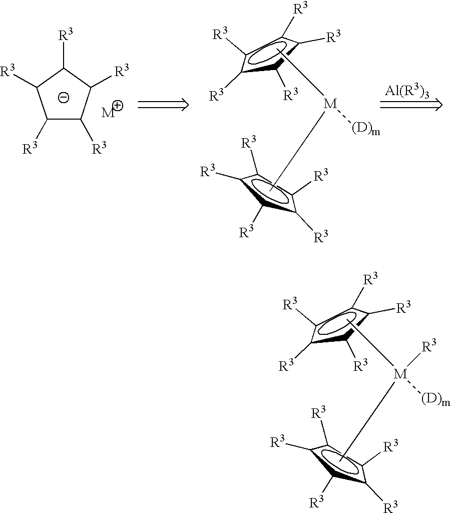

wherein M represents Sc, Y or a lanthanide atom, R³ groups independently represent a C₁₋₁₀ alkyl group, D is a solvent molecule and m is an integer of 0 to 3.

However, the pentaalkyl cyclopentadienyl salt described above should be synthesized by a process shown in the reaction scheme 3:

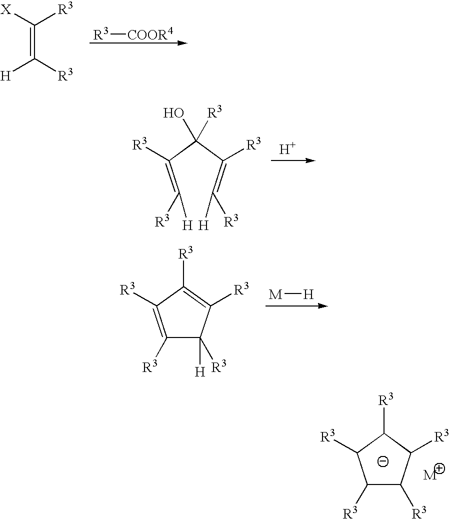

wherein M represents Sc, Y or a lanthanide atom, R³ and R⁴ independently represent a C₁₋₁₀ alkyl group, X represents a halogen atom, D is a solvent molecule and m is an integer of 0 to 3, and because of its yield during the process and troublesome isolation and purification, the pentaalkyl cyclopentadienyl salt cannot be said to be an easily obtainable, economical compound. Because of this expensive material, the organic lanthanoid complex catalyst itself is also expensive, and thus there is a problem that this catalyst is somewhat unsuited for large-scale industrial use.

### SUMMARY OF THE INVENTION

An object of this invention is to provide an easily synthesized trivalent organic lanthanoid complex which can be used as a polymerization catalyst for (meth) acrylic monomers.

Another object of this invention is to provide a process for producing a (meth) acrylic polymer by using the organic lanthanoid complex as the catalyst.

As a result of extensive study for solving the problem, the present inventors found the following trivalent organic lanthanoid complex different in the structure and ligand from conventional trivalent organic lanthanoid complexes, to arrive at completion of this invention.

That is, this invention relates to a trivalent organic lanthanoid complex represented by the general formula (1):

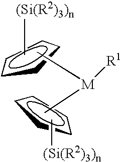

wherein M represents Sc, Y or a lanthanide atom, R¹ represents a hydrogen atom, a C₁₋₁₀ alkyl group or a C₁₋₁₀ alkyl group containing a silicon atom, R² groups independently represent a C₁₋₁₀ alkyl group, and n is 1 or 2.

Further, this invention relates to a catalyst for production of a (meth) acrylic polymer, which comprises the trivalent organic lanthanoid complex described above.

Further, this invention relates to a process for producing a (meth) acrylic polymer, which comprises polymerizing a (meth) acrylic monomer in the presence of the catalyst described above.

In the above process, methacrylate can be used as the (meth) acrylic monomer, to produce a highly syndiotactic methacrylic polymer.

The starting material of the trivalent organic lanthanoid complex of the invention can be easily produced. Further, the effect of the trivalent organic lanthanoid complex of the invention as a polymerization catalyst for (meth) acrylic monomers is equal to or higher than that of the organic lanthanoid complex descried in JP-A 3-263412. The (meth) acrylic monomers are polymerized in substantially the same polymerization mechanism as in the above publication. When the methacrylic monomers are polymerized, highly syndiotactic, stereoregularity methacrylic polymers particularly having 50% or more syndiotacticity can be obtained. Further, high-molecular-weight (meth) acrylic polymers having a narrow distribution of molecular weights can be obtained.

### BRIEF DESCRIPTION OF THE DRAWINGS

FIG. 1 is the molecular stereostructure of ((C₅H₃(TMS)₂)₂SmCl₂Me)₂ obtained in Example 1, which was determined by single-crystal X-ray structural analysis.

FIG. 2 is a GPC chart of the methacrylic polymer obtained in Example 2.

FIG. 3 is a ¹H-NMR chart of the methacrylic polymer obtained in Example 2.

### DETAILED DESCRIPTION OF THE INVENTION

The trivalent organic lanthanoid complex of the invention is represented by the general formula (1):

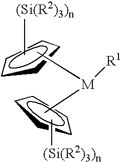

wherein M represents Sc, Y or a lanthanide atom, R¹ represents a hydrogen atom, a C₁₋₁₀ alkyl group or a C₁₋₁₀ alkyl group containing a silicon atom, R² groups independently represent a C₁₋₁₀ alkyl group, and n is 1 or 2.

In the presence of a solvent, the trivalent organic lanthanoid complex represented by the general formula (1) is used as a complex structure of monomers represented by the formula:

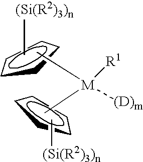

wherein M, R¹ and R² have the same meaning as defined above, D is a solvent molecule, and m is an integer of 0 to 3, while in the absence of a solvent, the trivalent organic lanthanoid complex is used as a dimerized complex structure represented by the formula:

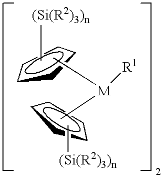

wherein M, R¹ and R² have the same meaning as defined above.

Examples of the lanthanide atom in the general formula (1) include, for example, La, Ce, Pr, Nd, Pm, Sm, Eu, Gd, Tb, Dy, Ho, Er, Tm, Yb, Lu etc. M is preferably Sm. The C₁₋₁₀ alkyl group represented by R¹ and R² includes linear or branched alkyl groups such as a methyl group, ethyl group, propyl group, butyl group and t-butyl group.

As the trivalent organic lanthanoid complex represented by the general formula (1) above, those compounds satisfying the above structural formula can be used without particular limitation. Examples thereof include bis[bis(trimethylsilyl)cyclopentadienyl] lutetium hydride, bis[bis(trimethylsilyl)cyclopentadienyl] lutetium methyl, bis[bis(trimethylsilyl)cyclopentadienyl] lutetium bistrimethyl silylmethyl, bis[(trimethylsilyl)cyclopentadienyl] lutetium hydride, bis[(trimethylsilyl)pentadienyl] lutetium methyl, bis[(trimethylsilyl)cyclopentadienyl] lutetium bistrimethyl silylmethyl, bis[bis(trimethylsilyl)cyclopentadienyl] ytterbium hydride, bis[bis(trimethylsilyl)cyclopentadienyl] ytterbium methyl, bis[bis(trimethylsilyl)cyclopentadienyl] ytterbium bistrimethyl silylmethyl, bis[(trimethylsilyl)cyclopentadienyl] ytterbium hydride, bis[(trimethylsilyl)cyclopentadienyl] ytterbium methyl, bis[(trimethylsilyl)cyclopentadienyl] ytterbium bistrimethyl silylmethyl, bis[bis(trimethylsilyl)cyclopentadienyl] samarium hydride, bis[bis(trimethylsilyl)cyclopentadienyl] samarium methyl, bis[bis(trimethylsilyl)cyclopentadienyl] samarium bistrimethyl silylmethyl, bis[(trimethylsilyl)cyclopentadienyl] samarium hydride, bis[(trimethylsilyl)cyclopentadienyl] samarium methyl, bis[(trimethylsilyl)cyclopentadienyl] samarium bistrimethyl silylmethyl, bis[bis(trimethylsilyl)cyclopentadienyl] europium hydride, bis[bis(trimethylsilyl)cyclopentadienyl] europium methyl, bis[bis(trimethylsilyl)cyclopentadienyl] europium bistrimethyl silylmethyl, bis[(trimethylsilyl)cyclopentadienyl] europium hydride, bis[(trimethylsilyl)cyclopentadienyl] europium methyl, bis[(trimethylsilyl)cyclopentadienyl] europium bistrimethyl silylmethyl, bis[bis(trimethylsilyl)pentadienyl] scandium hydride, bis[bis(trimethylsilyl)cyclopentadienyl] scandium methyl, bis[bis(trimethylsilyl)cyclopentadienyl] scandium bistrimethyl silylmethyl, bis[(trimethylsilyl)cyclopentadienyl] scandium hydride, bis[(trimethylsilyl)cyclopentadienyl] scandium methyl and bis[(trimethylsilyl)cyclopentadienyl] scandium bistrimethyl silylmethyl.

The method of producing a trivalent organic lanthanoid complex represented by the general formula (1) is not particularly limited. The complex can be produced by known methods described in e.g. Journal of the American Chemical Society, Tobin J. Marks, 107: 8091, 1985, Journal of the American Chemical Society, William J. Evans, 105: 1401, 1983, American Chemical Society Symposium, P. L. Watson, p. 495, 1983, and WO86/05788 (Tobin J. Marks), JP-A 3-263412 and JP-A 6-256419.

Specifically, as shown in e.g. the reaction scheme 8:

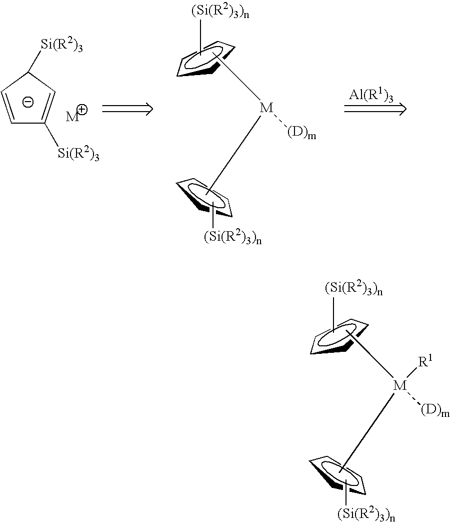

wherein M, R¹, R², n, D and m have the same meaning as defined above, the cyclopentadienyl salt containing a (trialkyl-substituted silyl) group is reacted with a lanthanide halide to produce an intermediate biscyclopentadienyl derivative which is then reacted with an organoaluminum compound represented by Al(R¹)₃ to produce the trivalent organic lanthanoid complex.

The cyclopentadienyl salt containing a (trialkyl-substituted silyl) group is synthesized by the reaction scheme 9:

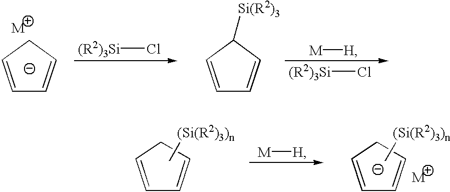

wherein M, R² and n have the same meaning as defined above. Production of the starting material by this synthesis method is easy because side reactions hardly occur, thus making the procedure of isolation and purification unnecessary. Accordingly, the trivalent organic lanthanoid complex of the invention can be synthesized more easily than conventional pentaalkyl cyclopentadienyl type organic lanthanide complexes, and is thus economically advantageous.

The trivalent organic lanthanoid complex of the invention can be used as a polymerization catalyst for (meth)acrylic monomers. The (meth)acrylic monomers in this invention refer to acrylic monomers and/or methacrylic monomers.

The (meth)acrylic monomers are not particularly limited, and include, for example, alkyl methacrylates whose alkyl group contains 1 to 12 carbon atoms. The alkyl group may be linear or branched. The alkyl (meth)acrylic esters include, for example, methyl (meth)acrylate, ethyl (meth)acrylate, n-propyl (meth)acrylate, isopropyl (meth)acrylate, t-butyl (meth)acrylate, n-hexyl (meth)acrylate, cyclohexyl (meth)acrylate, n-octyl (meth)acrylate, isooctyl (meth)acrylate, 2-ethylhexyl (meth)acrylate, and decyl (meth)acrylate. Further, the (meth)acrylic esters include those having, as an ester group, an aryl group, an alicyclic hydrocarbon group, and various hydrocarbon groups containing a halogen atom, a nitrogen atom, an oxygen atom etc. These can be used singly or in combination thereof.

The amount of the catalyst (i.e. trivalent organic lanthanoid complex) used is not particularly limited, and can be suitably regulated depending on the molecular weight of the (meth)acrylic polymer. Usually, the amount of the catalyst is preferably about 0.001 to 100 mmol, more preferably 0.01 to 10 mmol, per mole of the (meth)acrylic monomer. In an amount of less than 0.001 mmol, the polymerization activity is easily lowered, while in an amount of higher than 100 mmol, the molecular weight of the polymer formed is decreased and the desired physical properties are hardly obtained.

Polymerization of the (meth)acrylic monomer is carried out preferably in a solvent in an inert gas atmosphere. The inert gas includes, but is not limited to, nitrogen, argon and helium. For easy replacement of gas in the polymerization unit, argon is preferable. The solvent includes, for example, aromatic hydrocarbons such as benzene, toluene and xylene; aliphatic hydrocarbons such as hexane and heptane; alicyclic hydrocarbons such as cyclohexane and cycloheptane; hydrocarbon halides tetrahydrofuran such as methylene chloride and carbon tetrachloride; ethers such as diethyl ether; and esters such as ethyl acetate. The solvent is preferably the sufficiently dehydrated and degassed one. The amount of the solvent used is not particularly limited, but the solvent is used preferably in a ratio of 10 to 500 parts by volume, more preferably 100 to 200 parts by volume, to 10 parts by volume of the starting (meth)acrylic monomer.

The polymerization may be carried out by adding the trivalent organic lanthanoid complex to a solvent containing the (meth)acrylic monomer, or by adding the (meth)acrylic monomer to a solvent containing the trivalent organic lanthanoid complex, or with a solvent containing the (meth)acrylic monomer and the trivalent organic lanthanoid complex.

It is desired that the (meth)acrylic monomer is dissolved in the solvent, sufficiently dried by a drying agent such as molecular sieves, and used after the drying agent is removed just before polymerization. It is also desired that the trivalent organic lanthanoid complex is previously dissolved in the solvent before the starting (meth)acrylic monomer is polymerized.

In the polymerization described above, the polymerization temperature is not particularly limited, but when a solvent is used, the temperature is controlled between the melting point and boiling point of the solvent. Usually, the polymerization temperature is set preferably at about −100 to 100° C. The polymerization temperature is more preferably −100 to 50° C., still more preferably −100 to 25° C. When the polymerization temperature is too low, the viscosity of the polymerization solvent may be increased thus making it difficult to regulate the polymerization. On the other hand, when the polymerization temperature is too high, the reaction temperature may arrive at the boiling point of the polymerization solvent or thereabout, thus making it difficult to regulate the polymerization. The polymerization can be carried out at normal pressures or under pressure. Usually, the polymerization pressure is preferably about 1 to 50 atmospheric pressure. The pressure is more preferably 1 to 5 atmospheric pressure. The polymerization time can be regulated suitably depending on the molecular weight of the methacrylic syndiotactic polymer (I). Usually, the total polymerization time is 10 minutes to 100 hours. The polymerization time is preferably 3 hours to 30 hours.

The number-average molecular weight (Mn) of the resulting (meth)acrylic polymer is 5000 to 2000000, indicating that this polymer has a high molecular weight. The poly dispersity coefficient (Mw/Mn), that is, the ratio of the weight-average molecular weight (Mw) to the number-average molecular weight (Mn), is from 1 to 1.5, indicating a narrow distribution of molecular weights. The poly dispersity coefficient (Mw/Mn) is preferably from 1 to 1.2 for a narrower distribution of molecular weights. The number-average molecular weight and weight-average molecular weight are molecular weights determined by gel permeation chromatography (GPC, solvent: tetrahydrofuran) with polystyrene standards of known molecular weights. The method will be described in more detail in the Examples.

When the methacrylic monomer is polymerized, a methacrylic syndiotactic polymer is obtained. Its syndiotacticity in 3-units expression (% rr) is 70% or more, indicating high stereoregularity. The syndiotacticity in 3-units expression (% rr) is 70% or more, preferably 80% or more. The tacticity is determined by ¹H-NMR. The method will be described in more detail in the Examples.

The trivalent organic lanthanoid complex of the invention is superior in productivity because its starting material can be easily produced. Further, the trivalent organic lanthanoid complex is useful as a polymerization catalyst for (meth)acrylic monomers, and can be used to produce high-molecular-weight (meth)acrylic polymers having a very narrow distribution of molecular weights in high yield. In particular, when methacrylic monomers are polymerized, highly syndiotactic methacrylic polymers can be obtained. The resulting (meth)acrylic polymers can be utilized as various polymer materials excellent in moldability in various fields.

### EXAMPLES

Hereinafter, this invention is described in more detail by reference to the Examples, but this invention is not limited to the Examples.

The number-average molecular weight (Mn) and the poly dispersity coefficient (Mw/Mn) in the Examples were measured in tetrahydrofuran as the solvent at 40° C. by gel permeation chromatography (GPC) with SC-8010/TSK gel G2000, 3000, 4000 and 5000 columns produced by Tosoh Co., Ltd. In the Examples, 3-units expression (% rr) was calculated from the integration ratio of protons of linear and branched methyl groups by ¹H-NMR by using AMX400 produced by Bruker Co., Ltd.

### Example 1

### (Synthesis of the Trivalent Organic Lanthanoid Complex): Synthesis of bis[bis(trimethylsilyl)cyclopentadienyl] Samarium Methyl

<Synthesis of bis(trimethylsilyl)cyclopentadienyl Lithium Salt>

Synthesis was carried out according to the reaction scheme 10:

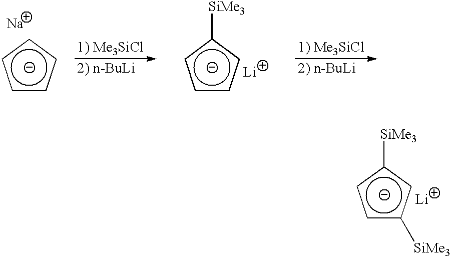

A cyclopentadienyl sodium salt (23 g, 268 mmol) prepared by reaction of cyclopentadiene with sodium was dissolved in 500 ml tetrahydrofuran (referred to hereinafter as THF). Trimethylsilyl chloride (TMSCL where TMS is trimethylsilyl) (30 g, 276 mmol) diluted with THF (100 ml) was dropped at −30° C. into the solution under stirring, and after dropping, the mixture was stirred at room temperature for 24 hours. After reaction, the solvent was removed from the reaction solution under vacuum. Pentane was added to the residues, and the byproduct LiCl was removed. After filtration, the filtrate was concentrated and distilled under reduced pressure to give C₅H₅SiMe₃ as colorless oil matter (33 g).

The C₅H₅TMS (19 g, 137 mmol) obtained as described above was dissolved in 200 ml dry THF and then cooled to −30° C. 86 ml of 1.6 mol/l n-butyl lithium in dry hexane was dropped at 30° C. to this solution, and after dropping, the mixture was stirred at room temperature for 24 hours. TMSCL (16 g, 147 mmol) diluted with THF (100 ml) was dropped at −30° C. into the reaction mixture under stirring, and after the reaction, the solvent was removed from the reaction solution under vacuum. Pentane was added to the residues, and the byproduct LiCl was removed. After filtration, the filtrate was concentrated and distilled under reduced pressure to give C₅H₄(TMS)₂ as oily matter (23 g).

The oily matter of C₅H₄(TMS)₂ (21.5 g, 10.2 mmol) obtained as described above was dissolved in 100 ml dry THF and cooled to −30° C. 64 g of 1.6 mol/l n-butyl lithium in dry hexane was dropped thereto under cooling. After dropping, the mixture was stirred at room temperature for 24 hours, and the solvent was removed under vacuum, whereby bis(trimethylsilyl)trimethylcyclopentadienyl lithium salt (C₅H₃(TMS)₂.Li) was obtained (22 g).

<Synthesis of bis[bis(trimethylsilyl)cyclopentadienyl] Samarium Methyl>

3.6 g SmCl₃ and 20 ml THF were introduced into a 300-ml flask previously flushed with argon, and 70 ml THF solution containing 6.1 g bis(trimethylsilyl)pentadienyl lithium salt (C₅H₃(TMS)₂.Li) synthesized in the method described above was added thereto under stirring. The mixture was refluxed overnight under heating, and thereafter, the THF was removed under reduced pressure. Hexane was added to the solids, and the supernatant was recovered, concentrated under reduced pressure and cooled to 20° C., whereby (C₅H₃(TMS)₂)₂SmCl₂Li(THF)₂ was obtained. 7.0 g of this (C₅H₃(TMS)₂)₂SmCl₂Li(THF)₂ was dissolved in 70 ml toluene, and 10 ml of 1.0 mol/l methyl lithium in diethyl ether was added thereto, and the mixture was reacted under stirring. After the precipitates were removed, the solution was subjected to re-crystallization to give 6.1 g ((C₅H₃(TMS)₂)₂SmCl₂Me)2 (yield 16%).

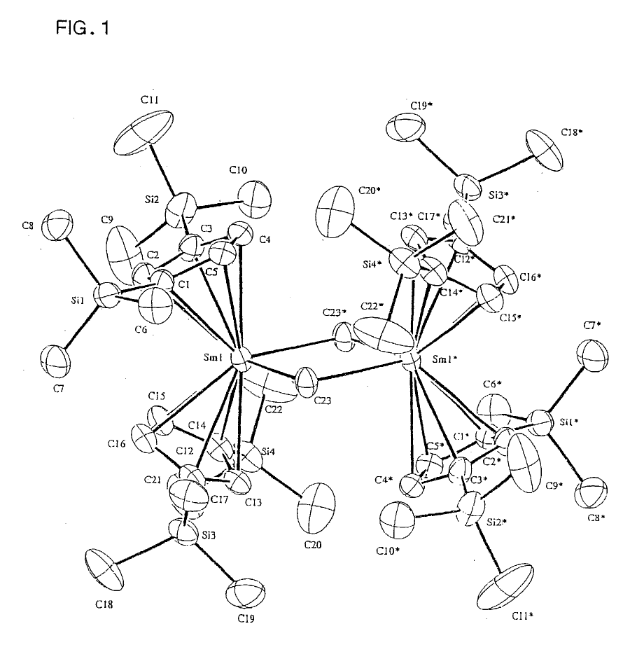

As a result of single-crystal X-ray structural analysis, the resultant recrystallized product was identified as ((C₅H₃(TMS)₂)₂SmCl₂Me)₂. Its molecular stereostructure is shown in FIG. 1. The single-crystal X-ray structural analysis was conducted by irradiation with graphite monochromatic molybdenum Kα rays by AFC-5R (Rigaku Co., Ltd.). The sample to be measured was instable in the air and thus sealed with an argon gas in a thin glass capillary tube. X-ray irradiation was conducted by a ω-2θ scan method, and X-ray data up to the maximum 2θ of 55.0° were taken. The data thus obtained were corrected in consideration of usual absorption and Lorentz effect. Determination of the relative position of each atom from the data was carried out by a Full-matrix least-squares method using a teXsan crystal software package (Molecular Structure Ltd.).

### Example 2

<Synthesis of Methacrylic Syndiotactic Polymer>

A 100-ml flask flushed with argon was charged with 234 mg (0.2 mmol) of ((C₅H₃(TMS)₂)₂SmCl₂Me)₂ and 20 ml toluene, and the mixture was cooled to 78° C., and then 20 g (200 mmol) degassed and dehydrated methyl methacrylate was added thereto. The mixture was subjected to polymerization reaction for 24 hours, and after drying, 20 g poly (methyl methacrylate) was obtained (yield 99%).

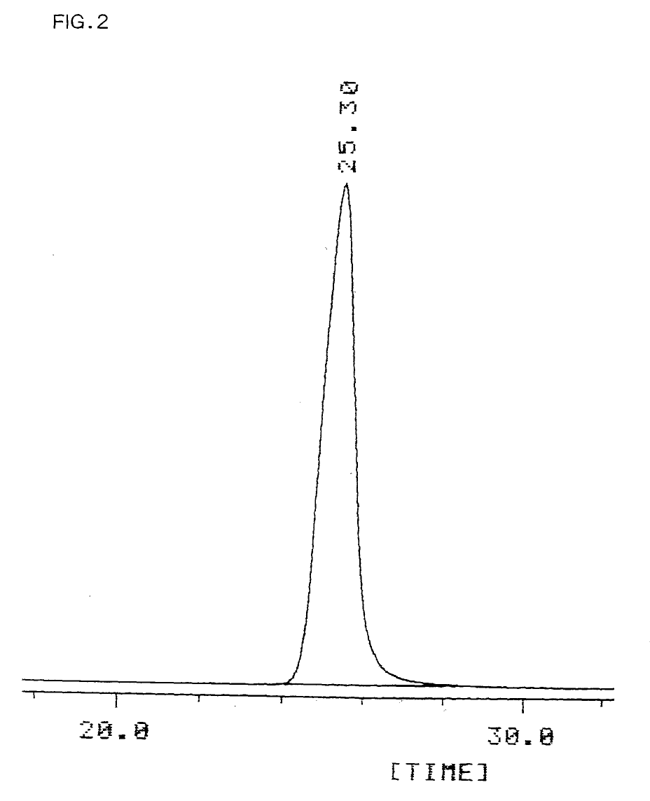

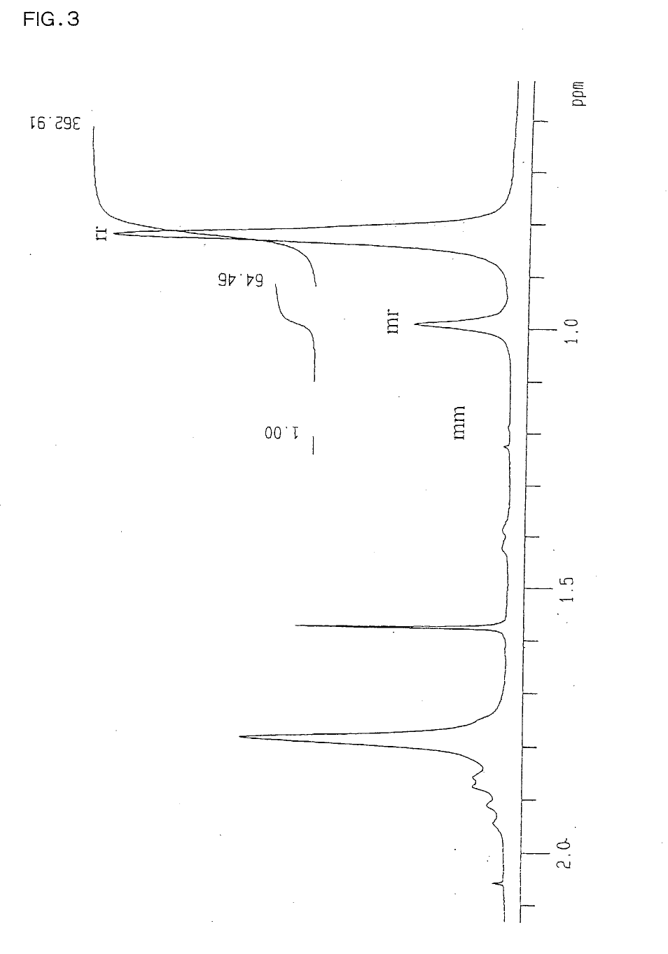

When the molecular weight of the resultant poly (methyl methacrylate) was measured by GPC, the weight-average molecular weight was 106,000, the number-average molecular weight was 96,000 and the poly dispersity coefficient was 1.17. The syndiotacticity of linkages in the poly (methyl methacrylate) was 85% in 3-units expression (% rr). A GPC chart of the poly (methyl methacrylate) is shown in FIG. 2, and a ¹H-NMR chart thereof is shown in FIG. 3.

### Example 3

<Synthesis of Methacrylic Syndiotactic Polymer>

Poly (ethyl methacrylate) was obtained (yield 96%) in the same manner as in Example 2 except that 22.8 g ethyl methacrylate was used in place of methyl methacrylate in Example 2.

When the molecular weight of the resultant poly (ethyl methacrylate) was measured by GPC, the weight-average molecular weight was 83,000, the number-average molecular weight was 78,000 and the poly dispersity coefficient was 1.07. The syndiotacticity of linkages in the poly (ethyl methacrylate) was 84% in 3-units expression (%rr).

As is evident from the above results, a methacrylic polymer having a high molecular weight, a narrow distribution of molecular weights and highly syndiotactic methacrylic linkages can be obtained by the methods in Examples 2 and 3.

### Reference Example 1

### Synthesis of bis(pentamethyl cyclopentadienyl) Samarium Methyl

<Synthesis of Pentamethyl Cyclopentadienyl Potassium Salt>

Synthesis was carried out according to the reaction scheme 11:

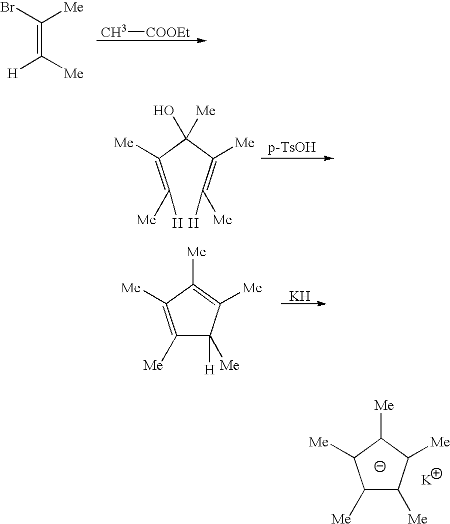

776 g dry THF was introduced into a reaction vessel equipped with a stirrer, a heating and cooling jacket, a nitrogen inlet tube, a dropping funnel, a reflux condenser and a thermometer, and then cooled to −15° C., and 200 parts of 30 weight-% dispersion of lithium (suspension in mineral oil) were added thereto under stirring and dispersed uniformly. Separately, 584 g of 2-bromo-2-butene was dissolved in 1163 g hexane. This solution was added dropwise over about 1 hour to the above lithium-containing dispersion kept at a temperature of −20 to −10° C. under stirring.

While this system was kept at −15° C. and stirred, a solution consisting of 190 g ethyl acetate and 569 g hexane was dropped into it over about 1 hour. Because the exothermic reaction proceeded during dropping, the reaction temperature was kept lower than −6° C. by cooling and regulating the rate of dropping. After dropping was finished, the mixture was returned once to room temperature and then stirred for 20 minutes. The reaction solution was cooled again to −15° C. and stirred while 3250 g aqueous saturated solution of ammonium chloride was dropped into it over 1 hour. Because the exothermic reaction occurred in this case too, the reaction temperature was regulated in the same manner as above.

When left, the reaction product was separated into an organic layer and aqueous layer. These layers were separated from each other, and the organic layer was washed with water, dried over sodium sulfate anhydride, and filtered. The reaction product thus obtained was purified by column chromatography and confirmed to be 3,4,5-trimethyl-2,5-pentadiene-4-ol by GC and IR.

45.5 g p-toluenesulfonic acid monohydrate was added to this solution, and the solvent was refluxed for 4 hours under heating and stirring. Then, the reaction solution was washed with water, and after the reaction solution was washed with an aqueous saturated solution of sodium hydrogencarbonate. Then, the reaction solution was washed with water, dried over sodium sulfate anhydride and filtered. The solvent was distilled away from the filtrate, whereby a slightly yellow oily matter was obtained. This product was distilled under reduced pressure, to give colorless oily 1,2,3,4,5-pentamethylcyclopentadiene in 59% yield on the basis of 2-bromo-2-butene.

38 g of 1,2,3,4,5-pentamethylcyclopentadiene obtained as described above was dissolved in 300 ml dry THF and cooled to −30° C. A suspension of KH (13 g) in 300 ml dry THF was cooled to −30° C., and the solution of 1,2,3,4,5-pentamethylcyclopentadiene in THF was dropped into it under cooling, and after dropping, the mixture was stirred at room temperature for 24 hours. After the reaction, excess KH was filtered off from the reaction solution, and the solvent was removed under vacuum, whereby bis(trimethylsilyl)trimethylcyclopentadienyl potassium salt was obtained (49.2 g).

<Synthesis of bis(pentamethylcyclopentadienyl) Samarium Methyl>

A 1-L flask flushed with argon was charged with 3.9616 g SmI₂ and 330 ml THF, and 45.8 g pentamethylcyclopentadienyl potassium salt ((C₅Me₅)K) was added thereto under stirring, and the mixture was reacted at room temperature. Thereafter, the THF was removed under reduced pressure, and toluene was added to the resultant solids, and the supernatant was recovered and concentrated under reduced pressure, and (C₅Me₅)Sm(THF)₂ was recrystallized from THF and hexane. 2.5 g (C₅Me₅)Sm(THF)₂ thus recrystallized was dissolved in 60 ml toluene, and 5 ml trimethyl aluminum was added thereto, and the mixture was reacted under stirring. After the precipitates were removed, the solution was subjected to re-crystallization, whereby (C₅Me₅)SmMe₂AlMe₂ was isolated. This product was recrystallized from THF and hexane, whereby (C₅Me₅)SmMe(THF) was obtained as orange crystals.

### Reference Example 2

### Synthesis of Methacrylic Syndiotactic Polymer by Using bis(pentamethylcyclopentadienyl) Samarium Methyl

20 g (200 mmol) methyl methacrylate and 20 ml toluene, which had been degassed and dehydrated, were introduced into a 100 ml flask previously flushed with argon, and then cooled to 0° C. A toluene solution (5 ml) containing 203 mg (0.4 mmol) (C₅Me₅)SmMe(THF) was added thereto. The solution was subjected to polymerization reaction for 2 hours, and after drying, 20 g poly (methyl methacrylate) was obtained (yield 99% or more).

When the molecular weight of the resultant poly (methyl methacrylate) was measured by GPC, the weight-average molecular weight was 83,000, the number-average molecular weight was 78,000 and the poly dispersity coefficient was 1.07. The syndiotacticity of linkages in the poly (methyl methacrylate) was 83% in 3-units expression (% rr).

What is claimed is:

1. A trivalent organic lanthanoid complex represented by the general formula (1): 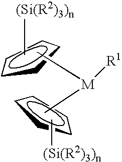
wherein M represents Sc, Y or a lanthanide atom, R¹ represents a hydrogen atom, a C₁₋₁₀ alkyl group or a C₁₋₁₀ alkyl group containing a silicon atom, R² groups independently represent a C₁₋₁₀ alkyl group, and n is 1 or 2.

2. A catalyst for production of a (meth) acrylic polymer, which comprises the trivalent organic lanthanoid complex described in claim 1.

3. A process for producing a (meth) acrylic polymer, which comprises polymerizing a (meth) acrylic monomer in the presence of the catalyst described in claim 2.

4. The process according to claim 3, wherein methacrylate is used as the (meth) acrylic monomer, to produce a highly syndiotactic methacrylic polymer.
